(19) United States
(12) Patent Application Publication
(10) Pub. No.: US 2005/0021411 A1
(43) Pub. Date: Jan. 27, 2005

(54) Product code availability

(76) Inventors: Glen J. Anderson, Sioux City, IA (US); James L. Kroening, Dakota Dunes, SD (US)

Correspondence Address: GATEWAY, INC.;ATTN: SCOTT CHARLES RICHARDSON, 610 GATEWAY DRIVE, MAIL DROP Y-04, N. SIOUX CITY, SD, 57049, US

(21) Appl. No.: 10/625,151

(22) Filed: Jul. 23, 2003

(51) Int. Cl. G06F 17/60

(52) U.S. Cl. 705/21

(57) ABSTRACT

A method, apparatus, system and signal-bearing medium, that saves a product code which enables use of a product on an electronic device. In various embodiments, the product code may be saved in the electronic device or at a server, either when the product is initially loaded in the electronic device or at a later, for example, when an update is loaded or maintenance is performed. When the product code is subsequently needed, the product code is retrieved from its saved location. In this way, the user is freed from needing to save and locate product codes written in booklets or pieces of paper.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### FIELD

This invention relates generally to product codes and more particular to providing access to a product code to enable use of a product.

### BACKGROUND

Providers of software products often use identification codes to protect against unauthorized copying of the products. If the proper identification code is not provided, the software will not install or will not run on the user's computer. These identification codes are also known as product keys, product passwords, certificates of authenticity, or product serial numbers. Users of the software often call the provider for help because they have difficulty entering their software product identification codes. The user may be entering the code incorrectly, may be entering the wrong code, or may have lost the code. Even if the user initially entered the code correctly, the code may be needed again if the software or the operating system needs to be reinstalled or if the storage device needs to be reformatted.

The user may have many products, each with a separate code, and these codes are only needed infrequently, so they may not be readily at hand. But, when the codes are needed, they are often needed urgently. Thus, keeping track of numerous product codes for numerous software products is a source of irritation even for the most organized user, and responding to calls from users who need help with their product codes is expensive for the product providers.

### SUMMARY

A method, apparatus, system, and signal-bearing medium are provided that in an embodiment saves a product code, which enables use of a product on an electronic device, when the product is initially loaded in the electronic device. In various embodiments, the product code may be saved in the electronic device or at a server. When the product code is subsequently needed, the product code is retrieved from its saved location. In this way, the user is freed from needing to save and locate product codes written in booklets or pieces of paper.

### BRIEF DESCRIPTION OF THE DRAWINGS

FIG. 1 depicts a block diagram of an example system for implementing an embodiment of the invention.

FIG. 2 depicts a flowchart of example processing, according to an embodiment of the invention.

FIG. 3 depicts a flowchart of example processing, according to another embodiment of the invention.

FIG. 4 depicts a flowchart of example processing for a manufacturing process for a product code addendum to an XPL (extended parts list), according to an embodiment of the invention.

FIG. 5 depicts a flowchart of example processing for a user power up product code process, according to an embodiment of the invention.

FIG. 6 depicts a flowchart of example processing for a replacement hard drive process, according to an embodiment of the invention.

FIG. 7 depicts a flowchart of example processing for a system restore process, according to an embodiment of the invention.

### DETAILED DESCRIPTION

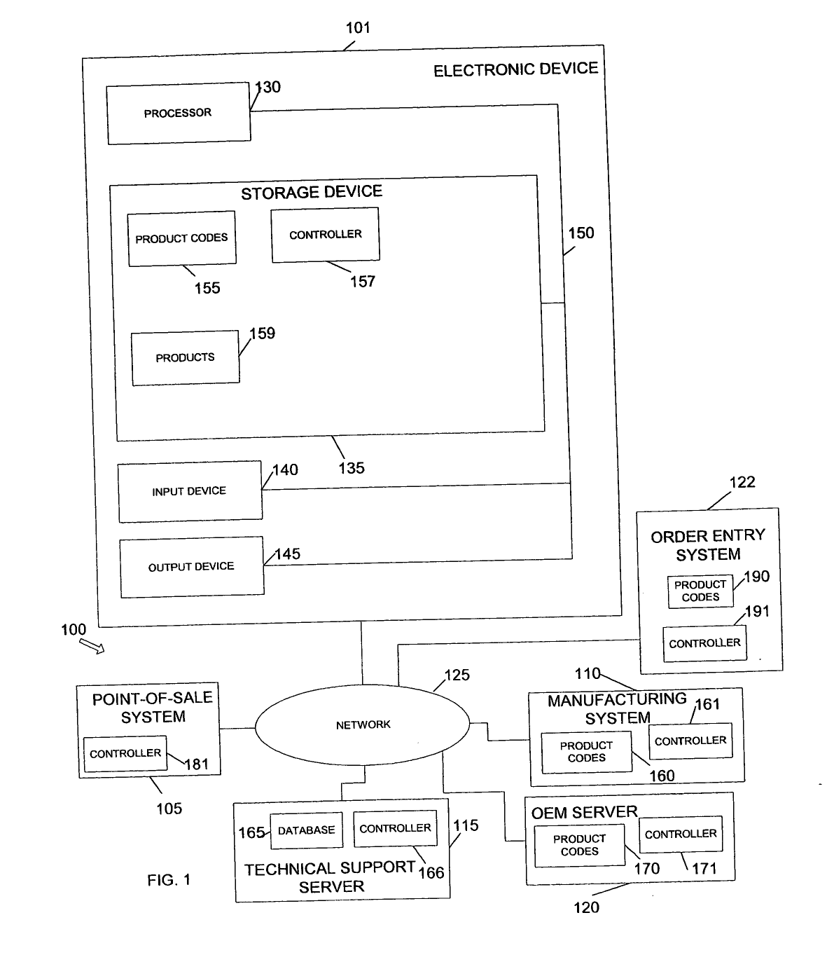

FIG. 1 depicts a block diagram of an example system 100 for implementing an embodiment of the invention. The system 100 includes a electronic device 101, a point-of-sale system 105, a manufacturing system 110, a technical support server 115, an OEM (Original Equipment Manufacturer) server 120, and an order entry system 122, connected via a network 125. Although only one electronic device 101, one point-of-sale system 105, one manufacturing system 110, one technical support server 115, one OEM server 120, one order entry system 122, and one network 125 are shown, in other embodiments any number or combination of them may be present. In another embodiment, some or all of the point-of-sale system 105, the manufacturing system 110, the technical support server 115, the OEM server 120, and the network 125 are not present.

The electronic device 101 includes a processor 130, a storage device 135, an input device 140, and an output device 145, all connected via a bus 150.

The processor 130 represents a central processing unit of any type of architecture, such as a CISC (Complex Instruction Set Computing), RISC (Reduced Instruction Set Computing), VLIW (Very Long Instruction Word), or a hybrid architecture, although any appropriate processor may be used. The processor 130 executes instructions and includes that portion of the electronic device 101 that controls the operation of the entire electronic device. Although not depicted in FIG. 1, the processor 130 typically includes a control unit that organizes data and program storage in memory and transfers data and other information between the various parts of the electronic device 101. The processor 130 receives input data from the input device 140 and the network 125, reads and stores code and data in the storage device 135, and presents data to the output device 145 and/or the network 125.

Although the electronic device 101 is shown to contain only a single processor 130 and a single bus 150, the present invention applies equally to electronic devices that may have multiple processors and multiple buses with some or all performing different functions in different ways.

The storage device 135 represents one or more mechanisms for storing data. For example, the storage device 135 may include read only memory (ROM), random access memory (RAM), magnetic disk storage media, optical storage media, flash memory devices, and/or other machine-readable media. In other embodiments, any appropriate type of storage device may be used. Although only one storage device 135 is shown, multiple storage devices and multiple types of storage devices may be present, and in various embodiments some or all of the product codes 155, the controller 157, and the products 159 may be stored on the same or on different storage devices. Further, although the electronic device 101 is drawn to contain the storage device 135, it may be distributed across other electronic devices, for example on computers attached to the network 125.

The storage device 135 includes product codes 155, a controller 157, and products 159. Although the product codes 155, the controller 157, and the products 159 are shown in FIG. 1 to be within the storage device 135 in the electronic device 101, some or all of them may be distributed across other systems, for example on a computer accessed via the network 125. Of course, the storage device 135 may also contain additional software and data (not shown), which are not necessary to understanding the invention.

The product codes 155 are identification codes that protect against use of unauthorized copies of the products 159. If the proper identification code is not provided, the product 159 will not install or will not run on the electronic device 101. The product codes 155 are also known as product keys, product passwords, certificates of authenticity, or product serial numbers. In various embodiments, the product codes 155 may be saved in a database, a file, a directory, a registry, a host-protected area, in the BIOS (Basic Input/Output System), or in any other appropriate storage location. In an embodiment, the product codes 155 are stored in an encrypted format.

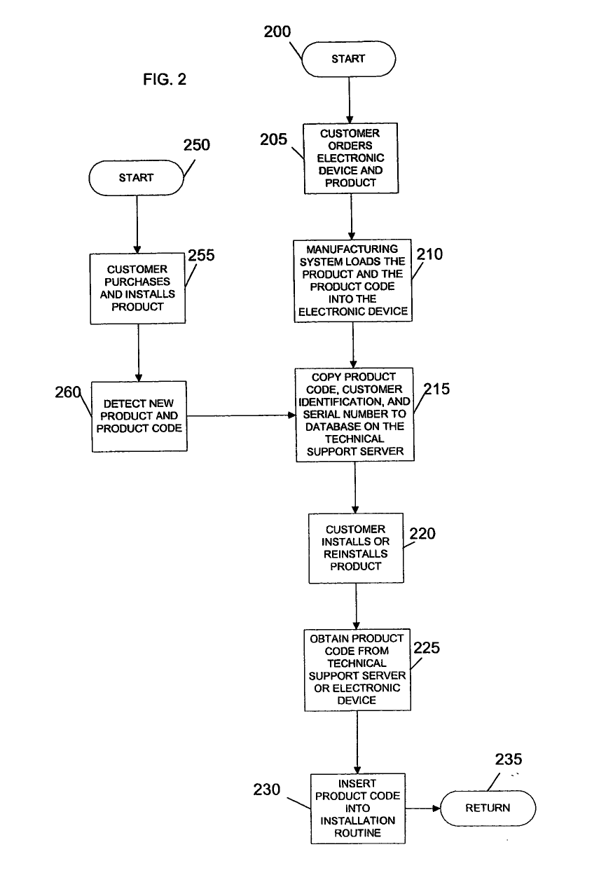

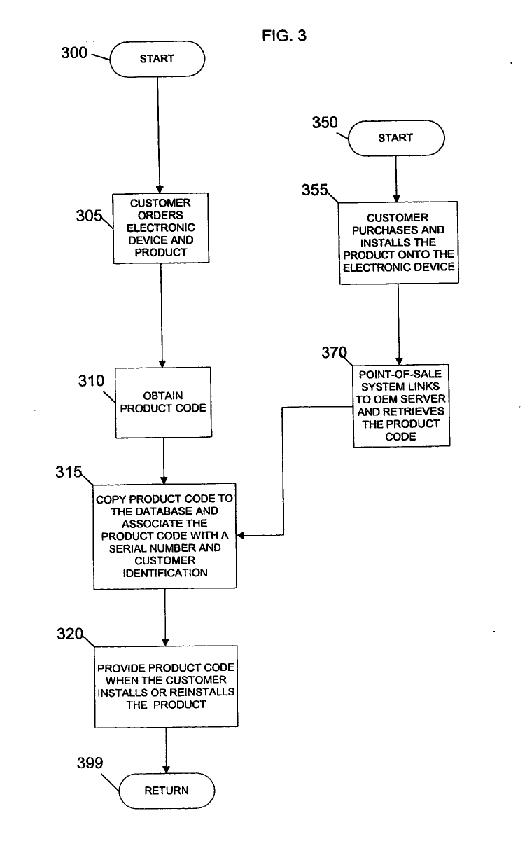

The controller 157 includes instructions capable of being executed on the processor 130 to carry out the functions of the present invention, as further described below with reference to FIGS. 2 and 3. In another embodiment, some or all of the functions of the present invention are carried out via hardware in lieu of a processor-based system.

The products 159 are software products that need the product codes 155 to install and/or run. In various embodiments, the products 159 may include instructions capable of being executed by the processor 130 or statements and/or data capable of being interpreted by another program (not shown) that executes on the processor 130.

The input device 140 may be a keyboard, mouse or other pointing device, trackball, touchpad, touchscreen, keypad, microphone, voice recognition device, or any other appropriate mechanism for the user to input data to the electronic device 101. Although one input device 140 is shown, in another embodiment any number (including none) and type of input devices may be present.

The output device 145 is that part of the electronic device 101 that communicates output to the user. The output device 145 may be a cathode-ray tube (CRT) based video display well known in the art of computer hardware. But, in other embodiments the output device 145 may be replaced with a liquid crystal display (LCD) based or gas, plasma-based, flat-panel display. In another embodiment, the output device 145 may be a speaker. In still other embodiments, any appropriate output device may be used. Although one output device 145 is shown, in other embodiments, any number (including none) of output devices of different types or of the same type may be present.

The bus 150 may represent one or more busses, e.g., PCI, ISA (Industry Standard Architecture), X-Bus, EISA (Extended Industry Standard Architecture), or any other appropriate bus and/or bridge (also called a bus controller).

The electronic device 101 may be implemented using any suitable hardware and/or software, such as a personal computer. Portable computers, laptop or notebook computers, PDAs (Personal Digital Assistants), pocket computers, telephones, pagers, appliances, and mainframe computers are examples of other possible configurations of the electronic device 101. The hardware and software depicted in FIG. 1 may vary for specific applications and may include more or fewer elements than those depicted. For example, other peripheral devices such as audio adapters, or chip programming devices, such as EPROM (Erasable Programmable Read-Only Memory) programming devices may be used in addition to or in place of the hardware already depicted.

The point-of-sale system 105 includes a controller 181. The controller 181 may be stored in a storage device analogous to the storage device 135 previously described above. In an embodiment, the controller 181 includes instructions capable of executing on a processor (not shown, but analogous to the processor 130 previously described above) to perform functions, as further described below with respect to FIG. 3. In another embodiment the controller 181 may be implemented in hardware. In an embodiment the point-of-sale system 105 may be a cash register or any other device capable of allowing a customer to purchase the electronic device 101.

The manufacturing system 110 includes product codes 160 and a controller 161. The product codes 160 and the controller 161 may be stored in a storage device (not shown) analogous to the storage device 135 previously described above. In an embodiment, the controller 161 includes instructions capable of executing on a processor (not shown, but analogous to the processor 130 previously described above) to perform functions, as further described below with respect to FIGS. 2 and 3. In another embodiment the controller 161 may be implemented in hardware.

The technical support server 115 includes a database 165 and a controller 166. The database 165 and the controller 166 may be stored in a storage device (not shown) analogous to the storage device 135 previously described above. The database 165 may include identifications of products 159 and the associated product codes 155 along with an identification of the customer that purchased the products 159 and/or an identification of the electronic device 101. In various embodiments, the identification of the customer may be a number and/or characters assigned by the manufacturer, the customer's name, the customer's telephone number, the customer's address, or any combination. In another embodiment, the identification of the customer may include a password. In another embodiment, the identification of the customer may be any appropriate identifying information. The identification of the customer may be encrypted. In an embodiment, the identification of the electronic device may be a serial number, a model number, a combination of serial number and model number, or any other appropriate identifying information.

In an embodiment, the controller 166 includes instructions capable of executing on a processor (not shown) to store and retrieve information in the database 165 in response to requests via the network 125, as further described below with respect to FIGS. 2 and 3. In another embodiment, the controller 166 may be implemented in hardware.

The OEM server 120 includes product codes 170 and a controller 171. In an embodiment, the OEM server 120 is associated with the provider of the product 159. The product codes 170 and the controller 171 may be stored in a storage device (not shown) analogous to the storage device 135 previously described above. In an embodiment, the controller 171 includes instructions capable of executing on a processor (not shown) to perform functions, as further described below with respect to FIG. 3. In another embodiment the controller 171 may be implemented in hardware.

The order entry system 122 includes product codes 190 and a controller 191. In an various embodiments, the order entry system 122 may be associated with the provider of the product 159 and/or the provider of the electronic device 101. The product codes 190 and the controller 191 may be stored in a storage device (not shown) analogous to the storage device 135 previously described above. In an embodiment, the controller 191 includes instructions capable of executing on a processor (not shown) to perform functions, as further described below with respect to FIGS. 2, 3, and 4. In another embodiment the controller 191 may be implemented in hardware. Although the product codes 190 are shown to be included within the order entry system 122, in other embodiments, the order entry system 122 may obtain the product codes from another system, e.g., the manufacturing system 110 or the OEM server 120, which contain respective product codes 160 or 170. Although the order entry system 122 is shown to be connected to the network 125, in another embodiment, the order entry system may stand alone.

The network 125 may be any suitable network or combinations of networks and may support any appropriate protocol suitable for communication between the electronic device 101, the point-of-sale system 105, the manufacturing system 110, the technical support server 115, the OEM server 120, and the order entry system 122.

As will be described in detail below, aspects of an embodiment pertain to specific apparatus and method elements implementable on a computer or other electronic device. In another embodiment, the invention may be implemented as a program product for use with an electronic device. The programs defining the functions of this embodiment may be delivered to an electronic device via a variety of signal-bearing media, which include, but are not limited to:
(1) information permanently stored on a non-rewriteable storage medium, e.g., a read-only memory device attached to or within an electronic device, such as a CD-ROM readable by a CD-ROM drive;
(2) alterable information stored on a rewriteable storage medium, e.g., a hard disk drive or diskette; or
(3) information conveyed to an electronic device by a communications medium, such as through a computer or a telephone network, including wireless communications.

Such signal-bearing media, when carrying machine-readable instructions that direct the functions of the present invention, represent embodiments of the present invention.

FIG. 2 depicts a flowchart of example processing, according to an embodiment of the invention. In an embodiment, control begins at block 200. Control then continues to block 205 where the customer orders the electronic device 101 and the product 159. In an embodiment, the customer may connect to the order entry system 122 via the network 125 to place the order. In another embodiment, the customer may place the order by talking to a marketing representative, who inputs data into the order entry system 122.

Control then continues to block 210 where the manufacturing system 110 loads the product 159 into the storage device 135 of the electronic device 101 and stores the product code 160 that is associated with the ordered product 159 in the electronic device 101 as product code 155. In another embodiment, the product 159 is included as external media with the electronic device 101 instead of being loaded into the storage device 135.

Control then continues to block 215 where the controller 161 in the manufacturing system 110 sends the product code 160, an identification of the customer, and/or and identification of the electronic device 101 to the technical support server 115. The controller 166 receives the sent information and stores it in the database 165. Control then continues to block 220 where the customer installs or reinstalls the product 159, and the installation or the reinstallation needs the product code.

Control then continues to block 225 where in an embodiment the controller 157 obtains the appropriate product code from the product codes 155. In another embodiment, the controller 157 sends a request containing the identification of the customer and/or the electronic device to the technical support server 115, and the controller 166 finds the appropriate code in the database 165 using the identification(s) and sends the product code back to the electronic device 101.

Control then continues to block 230 where the controller 157 inserts the retrieved product code into the installation routine that installs the product 159. In another embodiment a technician or other service representative communicates the product code to a user who supplies the product code to the installation routine. Control then continues to block 235 where the process completes.

In another embodiment, control begins at block 250. Control then continues to block 255 where the customer purchases the product 159 and starts the installation process. In an embodiment the customer purchases the product and downloads it to the electronic device 101 via the network 125. In another embodiment, the customer purchases the product at a retail store or other supplier. Controller then continues to block 260 where the controller 157 detects a product code for a product. In an embodiment the controller 157 detects a product code that was entered by the user. In another embodiment, the controller 157 detects a product code that was entered automatically during a download of the product 159.

Control then continues to block 215 where the controller 157 sends the detected product code, and identification of the customer and/or an identification of the electronic device 101 to the technical support server 115. The controller 166 at the technical support server 115 receives the information from the electronic device 101 and stores it in the database 165. Control then continues to block 220 as previously described above.

FIG. 3 depicts a flowchart of example processing, according to an embodiment of the invention. In an embodiment, control begins at block 300. Control then continues to block 305 where the customer orders the electronic device 101 and the product 159 via the order entry system 122. In various embodiments, the customer may place the order via telephone, over the Internet, at a store, or any other appropriate means for placing an order. Control then continues to block 310 where the controller 161 in the manufacturing system 110 obtains the product code associated with the ordered product. In an embodiment, the controller 161 obtains the product code from the product codes 160. In another embodiment, the controller 161 sends a request for the product code to the OEM server 120, where the controller 171 receives the requests and responds with the appropriate product code from the product codes 170. The OEM server 120 and the manufacturing system 110 may be owned and operated by the same company or by different companies.

Control then continues to block 315 where the controller 161 in the manufacturing system 110 sends the product code previously obtained at block 310 and an identification of the electronic device 101 and/or an identification of the product to the technical support server 115 where the controller 166 stores the received information in the database 165.

Control then continues to block 320 where when the customer installs or reinstalls the product, the controller 157 sends a request containing the identification of the customer and/or the electronic device to the technical support server 115, and the controller 166 finds the appropriate code in the database 165 using the identification and sends the product code back to the electronic device 101. The controller 157 inserts the retrieved product code into the installation routine that installs the product 159. In another embodiment, a technician or other service representative may supply the product code to a user, who provides it to the installation routine. Control then continues to block 399 where the process completes.

In another embodiment, control begins at block 350. Control then continues to block 355 where the customer purchases the electronic device 101 and the product 159 at a store having the point-of-sale system 105. Control then continues to block 370 where the controller 181 at the point-of-sale system 105 sends an identification of the purchased product, an identification of the customer, and/or an identification of the electronic device 101 to the OEM server 120 and requests the product code. The controller 171 receives the request, finds the product code using the identification of the purchased product, and sends the product code back to the point-of-sale system 105, where the controller 181 sends the product code to the electronic device 101, where the controller 157 loads the product code into the product codes 155.

Control then continues to block 315 where the controller 171 at the OEM server 120 sends the product code, the identification of the customer, and/or the identification of the electronic device 101 to the technical support server 166, where the controller 166 stores the received information in the database 165. Control then continues to block 320 as previously described above.

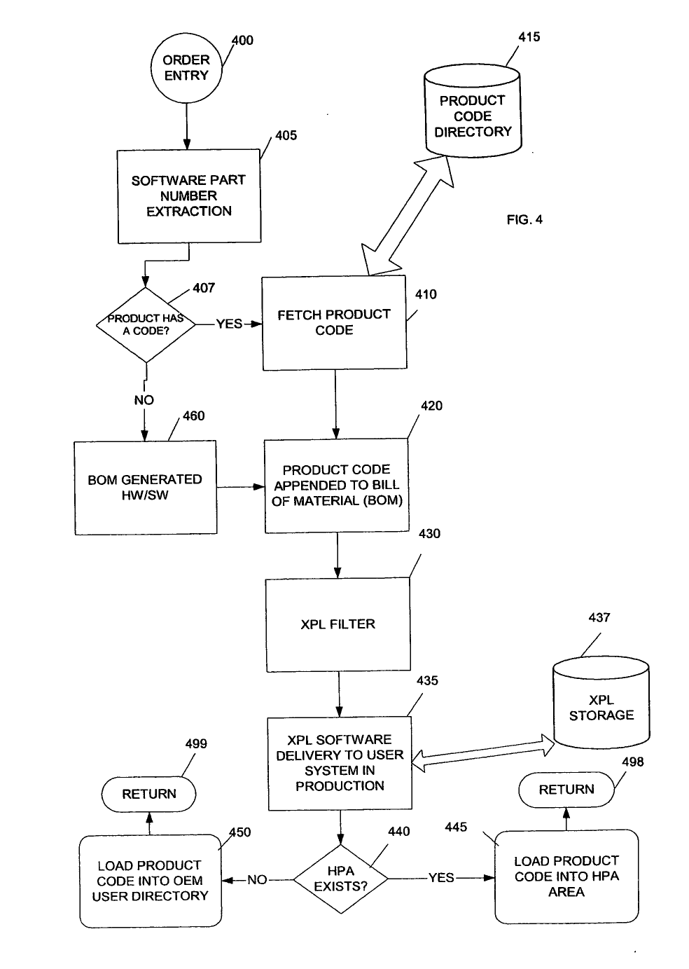

FIG. 4 depicts a flowchart of example processing for a manufacturing process for a product code addendum to an XPL (extended parts list), according to another embodiment of the invention. Control begins at block 400 where a customer places an order. The order may include the electronic device 101 and the product 159. Control then continues to block 405 where the controller 191 at the order entry system 122 extracts a software part number for the product 159 from the order, which may contain both hardware and software part numbers. Control then continues to block 407 where the controller 191 at the order entry system 122 determines whether the software product 159 associated with the software part number has a product code.

If the determination at block 407 is true, then control continues to block 410 where the controller 191 at the order entry system 122 fetches the product code from the product code directory 415. In various embodiments, the product code directory 415 may be the product codes 160, the product codes 170, or the product codes 190. Control then continues to block 420 where the controller 191 appends the product code to the bill of materials (BOM) for the order and sends the bill of materials to the manufacturing system 110. The BOM includes a list of all the hardware and software component parts that are to go into the customer's ordered system, the electronic device 101.

Control then continues to block 430 where the controller 161 at the manufacturing system 110 uses an extended parts list filter (XPL) at XPL storage 437 to filter from the BOM all of the hardware part numbers to leave only the software part numbers associated with the software image that is to be loaded onto the storage device 135. Control then continues to block 430 where the controller 161 delivers the software image, which includes the product 159, to the storage device 135 on the electronic device 101. Control then continues to block 440 where the controller 161 determines whether the storage device 135 includes a host protected area (HPA).

If the determination at block 440 is true, then control continues to block 445 where the controller 161 loads the product code into the product codes 155, which is in the HiPA area of the storage device 135. Control then continues to block 498 where the function returns.

If the determination at block 440 is false, then control continues to block 450 where the controller 161 loads the product code into the product codes 155, which is in an OEM (Original Equipment Manufacturer) directory in the user area of the storage device 135. Control then continues to block 499 where the function returns.

If the determination at block 407 is false, then control continues to block 460 where the controller 191 at the order entry system 122 creates the bill of materials for the hardware and software associated with the order and sends it to the manufacturing system 110. Control then continues to block 420 as previously described above.

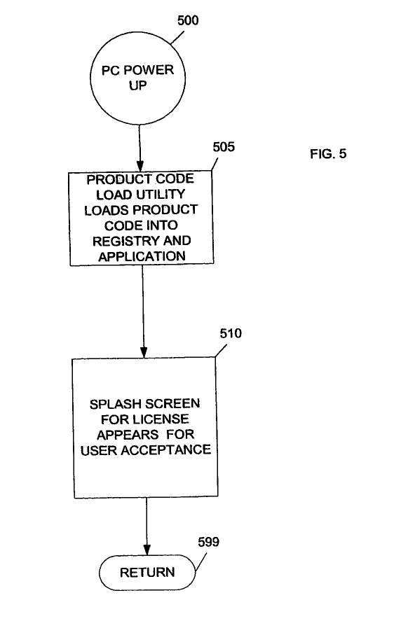

FIG. 5 depicts a flowchart of example processing for a user power up product code process, according to another embodiment of the invention. Control begins at block 500 where the electronic device 101 powers up. Control then continues to block 505 where a product code load utility (part of the controller 157) loads the product code 155 into an operating system registry and application block, which enables use of the product 159. Control then continues to block 510 where a screen shows a license agreement associated with the product 159 and asks the user for acceptance of the terms of the license agreement. Control then continues to block 599 where the function returns.

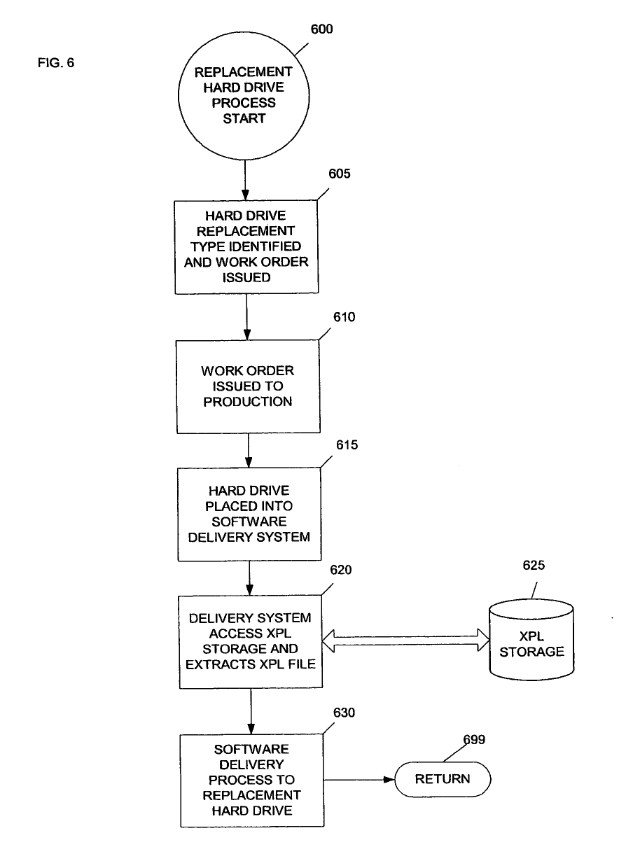

FIG. 6 depicts a flowchart of example processing for a replacement hard drive process, according to another embodiment of the invention. Control begins at block 600. Control then continues to block 605 where a technician determines that the storage device 135 needs to be replaced and issues a work order to order the correct type of replacement device. The work order includes the serial number or other information that identifies the electronic device 101. In another embodiment, the user decides to replace the storage device 135 and orders the proper type and includes information identifying the electronic device 101 with the order. Control then continues to block 610 where the work order is issued and received by the production department that provides the replacement storage device. Control then continues to block 615 where the production department obtains the ordered type of storage device and gives it to the software delivery system. Control then continues to block 620 where the software delivery system accesses the XPL storage 625 and extracts the XPL file associated with the serial number (or other identifying information) of the electronic device 101. The XPL file contains part numbers of the products 159 that need to be loaded on the new storage device that is to be installed in the electronic device 101. Control then continues to block 630 where the software delivery process saves the products 159 specified in the XPL file to the new storage device. Control then continues to block 699 where the function returns.

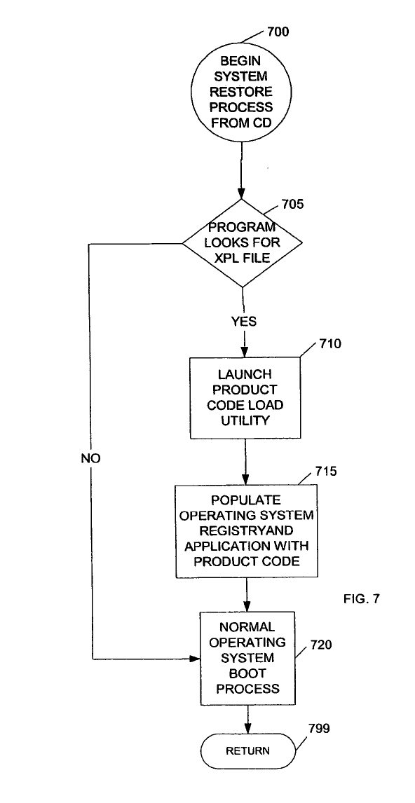

FIG. 7 depicts a flowchart of example processing for a system restore process, according to another embodiment of the invention. The functions of FIG. 7 are executed when the software image is reloaded to the storage device 135, for example if the data on the storage device 135 has been corrupted. The software image may be reloaded from a CD, tape, diskette, or other secondary storage device. Control begins at block 700. Control then continues to block 705 where the controller 157 determines whether an XPL file exists either in the HPA or in the user directory of the storage device 135. If the determination at block 705 is true, then control then continues to block 710 where the product code load utility (a portion of the controller 157) is launched. Control then continues to block 715 where the product code load utility populates the operating system registry and application with the product code 155. Control then continues to block 720 where the normal operating system boot process proceeds. Control then continues to block 799 where the function returns.

If the determination at block 705 is false, then control then continues from block 705 directly to block 720, as previously described above.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of the invention. However, it is understood that the invention may be practiced without these specific details. In other instances, well-known circuits, structures, and techniques have not been shown in detail in order not to obscure the invention.

1. A method comprising:
receiving an identification from an electronic device;
finding a product code associated with the identification; and
sending the product code to the electronic device;
wherein the product code enables use of a product on the electronic device, said product not being usable on the electronic device until being enabled with the product code.

2. The method of claim 1, further comprising:
copying the product code to a database when the product is purchased.

3. The method of claim 2, wherein the finding the product code further comprises finding the product code in the database.

4. The method of claim 1, further comprising:
copying the product code to a database when the product and the electronic device are purchased.

5. The method of claim 1, wherein the identification identifies the electronic device.

6. The method of claim 1, wherein the identification identifies a customer.

7. A signal-bearing medium bearing instructions that when executed comprise:
installing a product on an electronic device;
detecting a product code associated with the product; and
saving the product code in the electronic device;
wherein the product code enables use of the product, said product not being usable on the electronic device until being enabled with the product code.

8. The signal-bearing medium of claim 7, further comprising sending the product code and an identification to a server.

9. The signal-bearing medium of claim 8, wherein the identification identifies the electronic device.

10. The signal-bearing medium of claim 8, wherein the identification identifies a customer.

11. The signal-bearing medium of claim 8, further comprising:
retrieving the product code from the server when the product is reinstalled on the electronic device.

12. The signal-bearing medium of claim 11, further comprising:
inserting the product code into an installation routine for the product.

13. A point-of-sale system comprising:
a controller to send an identification of a product to a server, receive a product code from the server in response to the identification of the product, and send the product and the product code to an electronic device.

14. The point-of-sale system of claim 13, wherein the electronic device is purchased using the point-of-sale system.

15. The point-of-sale system of claim 13, wherein the product code enables use of the product on the electronic device.

16. A manufacturing system comprising:
a controller that loads a product and a product code into an electronic device, wherein the product code enables use of the product, and sends the product code and an identification of the electronic device to a server.

17. The manufacturing system of claim 16, wherein the controller further sends an identification of a customer who ordered the electronic device to the server.

18. The manufacturing system of claim 16, wherein the controller obtains the product code from a second server associated with a provider of the product.

19. An electronic device comprising:
a processor; and
a storage device, wherein the storage device comprises instructions, which when executed on the processor comprise:
installing a product on an electronic device,
detecting a product code associated with the product; and
saving the product code in the electronic device;
wherein the product code enables use of the product, said product not being usable on the electronic device until being enabled with the product code.

20. The electronic device of claim 19, wherein the instructions further comprise:
sending the product code and an identification to a server.

21. The electronic device of claim 20, wherein the identification identifies the electronic device.

22. The electronic device of claim 20, wherein the identification identifies a customer.

23. An apparatus comprising:
means for receiving an identification from an electronic device;
means for finding a product code associated with the identification; and
means for sending the product code to the electronic device;
wherein the product code enables use of a product on the electronic device, said product not being usable on the electronic device until being enabled with the product code.

24. A method comprising:
extracting a part number for software from an order for an electronic device;
fetching a product code based on the part number;
loading the software to the electronic device; and
loading the product code to the electronic device.

25. The method of claim 24, wherein the loading the product code further comprises:
loading the product code to a host protected area of a storage device associated with the electronic device when the host protected area exists.

26. The method of claim 25, where the loading the product code further comprises:
loading the product code to a user area of a storage device when the host protected area does not exist.

27. The method of claim 24, further comprising:
determining whether the part number has a product code prior to the fetching.

28. The method of claim 24, wherein the extracting the part number further comprises:
filtering out hardware part numbers from the order.

29. A signal-bearing medium bearing instructions that when executed comprise:
extracting a part number for software from an order for an electronic device;
fetching a product code based on the part number;
loading the software to the electronic device; and
loading the product code to the electronic device.

30. The signal-bearing medium of claim 29, wherein the loading the product code further comprises:
loading the product code to a host protected area of a storage device associated with the electronic device when the host protected area exists.

31. The signal-bearing medium of claim 30, where the loading the product code further comprises:
loading the product code to a user area of a storage device when the host protected area does not exist.

32. The signal-bearing medium of claim 29, further comprising:
determining whether the part number has a product code prior to the fetching.

33. The signal-bearing medium of claim 29, wherein the extracting the part number further comprises:
filtering out hardware part numbers from the order.
